(19) United States
(12) Patent Application Publication
(10) Pub. No.: US 2004/0216970 A1
(43) Pub. Date: Nov. 4, 2004

(54) Fold-out wheeled support for long, wheeled travel case

(76) Inventors: Gary Sherrell, Maple Valley, WA (US); William Pangburn, Renton, WA (US)

Correspondence Address: GRAYBEAL, JACKSON, HALEY LLP, 155 - 108TH AVENUE NE, SUITE 350, BELLEVUE, WA, 98004-5901, US

(21) Appl. No.: 10/730,639

(22) Filed: Dec. 8, 2003

Related U.S. Application Data
(60) Provisional application No. 60/467,032, filed on Apr. 30, 2003.

(51) Int. Cl. B62B 7/02; B62B 1/00

(52) U.S. Cl. 190/18 A; 280/47.17

(57) ABSTRACT

A wheeled extendable support for long travel cases. When long travel cases are balanced on one corner, a handle on the upper end is too high for ease of use. With this invention, the case is tilted to an angle of 45 degrees or less off the ground and the invented support which has wheels at the bottom is extended from the case to carry a portion of the weight, allowing the handle at the top of the case to be used at a comfortable height. The wheeled support may be built in or added on to a case. The extendable support includes a locking mechanism. The extendable support may be folded upward or downward when collapsed.

### BACKGROUND

People have been making specialized cases for use when traveling since the beginning of recorded history. Travel cases for long objects, such as golf clubs, are more awkward to handle than most cases. If the case is stood on end, it will easily fall over when bumped, so it is usually handled and placed in a horizontal orientation.

An important improvement for travel cases was the addition of two built-in wheels along one edge of the travel case opposite a built-in handle. For most travel cases, these edge wheels allow the travel case to be tilted to near a balance point and then pulled or pushed with the handle opposite the wheels. On paved surfaces, this makes it easy for a person to walk while pushing or pulling the travel case.

However, when travel cases that are much longer than they are high are heavily loaded, such as cases for golf clubs, the system of two edge wheels and an opposite handle does not work very well. When the case is tilted to its balance point, the tilt angle is too close to vertical to gain adequate control over the weight of the case. Consequently, the person must tilt the case much closer to horizontal than near the balance point and carry much of the weight in the person's hand, which presents a problem when the case is heavily loaded.

For short, heavily loaded, edge-wheeled travel cases, the problem can be solved by extending the handle so that most of the weight is on the wheels. Such travel cases with extendable handles are popular. However, if the case is long, longer than about 40 inches, and intended to carry significant weight, extending the handle enough to transfer adequate weight to the wheels would make the length of the tilted case plus extended handle too long for maneuvering through travel stations and around other baggage.

Consider the following geometric explanation of the problem. Travel cases longer than about 40 inches, such as for golf clubs, are always much longer than they are high. But let us consider a theoretical long travel case that is just as high (about 40 inches) as it is long. This case has a height (H in FIG. 3) to one side of the wheeled edge equal to a base length (L in FIG. 3) on the other side of the wheeled edge such that a vertical cross section of the case forms a square. If the weight inside the case is evenly distributed, the case will balance on the edge wheels when lifted to a tilt of 45 degrees. This angle is sufficient to give a person adequate control when pushing or pulling a typical size case. However, actual long cases have geometries that are more difficult because the height H is less than two-thirds of the length L. The actual case will have to be lifted much more than 45 degrees to reach its balance point. A high angle of lift, more than 45 degrees, leaves a loaded case difficult to control when pushed or pulled. When pushing at this angle, if the wheels hit a small bump, the momentum of the load will cause the case to lurch upright. If a person lowers the case enough to gain adequate control, less of the weight is now on the wheels and more of the weight is on the person's hand, which is tiring for the person when the case is heavy.

A popular travel case that particularly suffers from this problem is the travel case for golf clubs. The length of its base is more than twice the height of its side opposite the edge wheels. When loaded with golf clubs, it is quite heavy. When raised at a low enough angle to give adequate control, the weight on a person's hand is undesirably tiresome. A solution to this problem without adding an extension on the handle is needed.

### SUMMARY OF INVENTION

The invented solution to this problem is to raise the long travel case to less than 45 degrees, so that a large portion of the weight would be on the handle, and then add to the raised travel case a support that extends to the ground with one or more wheels on the end of the support. The support may be strapped on to a long case made without such a support or it may be built into a long case and designed to raise the case to less than 45 degrees. With this support, the case will not need an extendable handle and a handle that protrudes no more than 6 inches from the case will be at a suitable height above the ground when the wheeled support is extended.

In one aspect, the invention is an add-on support for wheeled travel cases such as golf travel cases. The add-on support has an attachment structure that is attachable to a side of a wheeled travel case such as by using attached straps that strap around the case. One end of an elongated extendable support is attached to the attachment structure and the other end of the elongated extendable support has one or two or more wheels. A locking mechanism locks the extendable support in an extended position relative to the attachment structure.

This add-on support can be attached to any travel case having edge wheels at an edge of the travel case and a handle at an opposite end of the travel case. The support can be collapsed against the side of the travel case or extended and locked in position. When extended, the travel case is tilted at a low enough angle to put substantial weight on the support wheels, which maintains the travel case in a stable position on any substantially level surface.

The support wheels may be caster wheels mounted on pivot shafts that are substantially vertical when the extendable support is extended and the case is tilted such that the attached wheels carry load on a level surface.

The attachment structure includes a hook at a lower end of the attachment structure that restrains the attachment structure from sliding up relative to a travel case when the case is tilted such that weight is on the extendable support. The extendable support may be pivotally attached to the attachment structure such that, when the extendable support is collapsed against the attachment structure, the support wheel is near a lower edge of the attachment structure. Alternatively, the extendable support may be pivotally attached to the attachment structure such that, when it is collapsed, the support wheel is near an upper end of the attachment structure.

In another aspect, the invention is a long edge-wheeled travel case, longer than 40 inches, with an extendable wheeled support that supports the case at a tilt of less than 45 degrees from horizontal. The travel case has two edge wheels mounted on a bottom edge of a side of the case such that, when the case is raised opposite that side, the case rests on the two wheels. The travel case has a height H (see FIG. 3) that is substantially less than its length L, and a handle opposite the edge wheels that protrudes no more than 6 inches. One end of an elongated extendable support is attached to the base of the case and another end of the support has one or more wheels. A locking mechanism locks the extendable support into an extended position relative to the travel case.

The travel case may be hard, such as a fiberglass or other fiber plus adhesive composite or polymer or metal. Alternatively, the case may have a soft exterior made of cloth with a rigid frame on the interior connecting the two edge wheels at one end of the case, the extendable support attached to the base of the case, and the handle opposite the edge wheels.

Like for the add-on support, the wheels may be caster wheels and the extendable support may be configured to pivot toward the wheeled end of the case or toward the handle end of the case when collapsed.

### BRIEF DESCRIPTION OF THE DRAWINGS

The features of the present invention which are believed to be novel are set forth with particularity in the appended claims. Aspects of the invention, together with further objects and advantages thereof, may best be understood by making reference to the following description taken in conjunction with the accompanying drawings wherein:

FIG. 1 shows the add-on wheeled support.

FIG. 2 shows a long wheeled travel case with an extendable wheeled support which is an integrated support.

FIG. 3 shows a long wheeled travel case with an extendable wheeled support with a custom riveted add-on support.

FIG. 4 shows the extendable wheeled support collapsed against the travel case near a handle end of the travel case or, if the support is the add-on type, near an upper end of the attachment frame.

### DETAILED DESCRIPTION

In the following detailed description of exemplary embodiments of the invention, reference is made to the accompanying drawings. The detailed description and the drawings illustrate specific exemplary embodiments by which the invention may be practiced. Other embodiments may be utilized, and other changes may be made, without departing from the spirit or scope of the present invention. The following detailed description is therefore not to be taken in a limiting sense, and the scope of the present invention is defined by the stated claims.

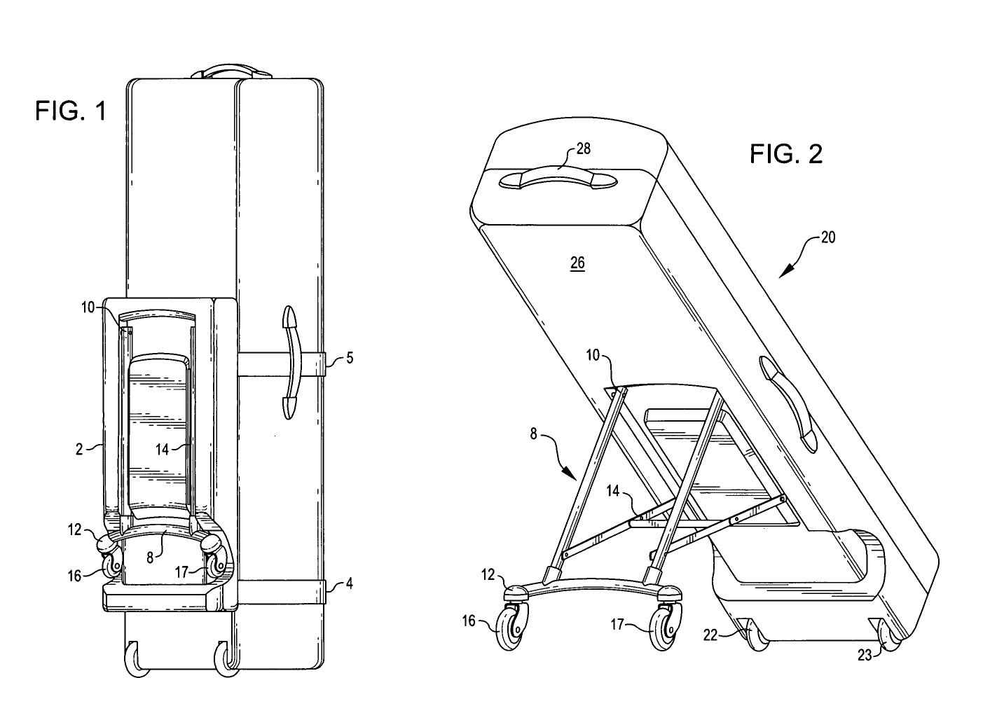

FIG. 1 shows an add-on extendable wheeled support. Its base component is an attachment structure 2 made of a molded polymer with enough depth to receive the folded support structure, long enough to provide adequate support to both the travel case and the extendable support and no wider than the travel case. Alternatively, the attachment structure may be a composite sheet approximately one-quarter to one-half inch thick. The attachment structure may be constructed as an open frame rather than a sheet. It may be attached to a travel case with a lower strap 4 and an upper strap 5 or by other means of attachment to the travel case.

The support 8 is designed to be extendable to stick out from the attachment structure 2 or collapse to be folded snuggly against the attachment structure or into recesses in the attachment structure. A locking mechanism 14 holds the support in an extended position relative to the attachment structure 2. The extendable support has an attachment end 10 and a wheeled end 12. The attachment end may be pivotally attached to the attachment structure 2. When extended into a locked position, the angle between the attachment structure 2 and the support 8 may be any angle. Preferred angles fall between 45 degrees and 90 degrees. At 45 degrees, the extendable support sticks straight down when the travel case is tilted 45 degrees. At 90 degrees, the support wheels form a wider base relative to the edge wheels than at smaller angles, providing a relatively stable base for a given length of extendable support. For most embodiments for most travel cases, the angle will fall between 45 degrees and 90 degrees, although it may be outside this range for some embodiments.

The embodiment shown in FIG. 1 has two wheels 16, 17 at the wheeled end of the support. Other embodiments may have one wheel or more than two wheels. The wheels may be caster wheels so that the travel case may be easily steered, pivoting about the edge wheels which are not caster wheels. Caster wheels work best when their pivot axes are substantially vertical. The angle at which the caster wheels are mounted to the end of the extendable support is designed to leave the pivot axes substantially vertical when the support is extended from a typical travel case.

FIG. 2 shows a wheeled travel case 20 with an extendable wheeled support. The portions of the support 8, including the wheels and locking mechanism 14 are the same as for the add-on support. However, instead of the attachment structure of the add-on support, the support 8 is attached directly to the structure of the case. The structure may be formed by the exterior of the case itself, such as in a hard case made of molded material, or the structure may be a frame, such as a metal frame, extending from the edge wheels 22, 23 to an attachment point for the extendable support 8 and to a handle 28. The extendable support 8 is attached to a base 26 of the case, and the edge wheels 22, 23 are at an end corner of the base.

The length of the support, angle of the support relative to the case when extended, and location of the support attachment to the case are chosen to tilt the case less than 45 degrees as indicated in FIG. 4. In some embodiments, it works best if the tilt angle is less than 40 degrees from the ground. For one embodiment for a golf travel case, 33 degrees from the ground was found to be optimal.

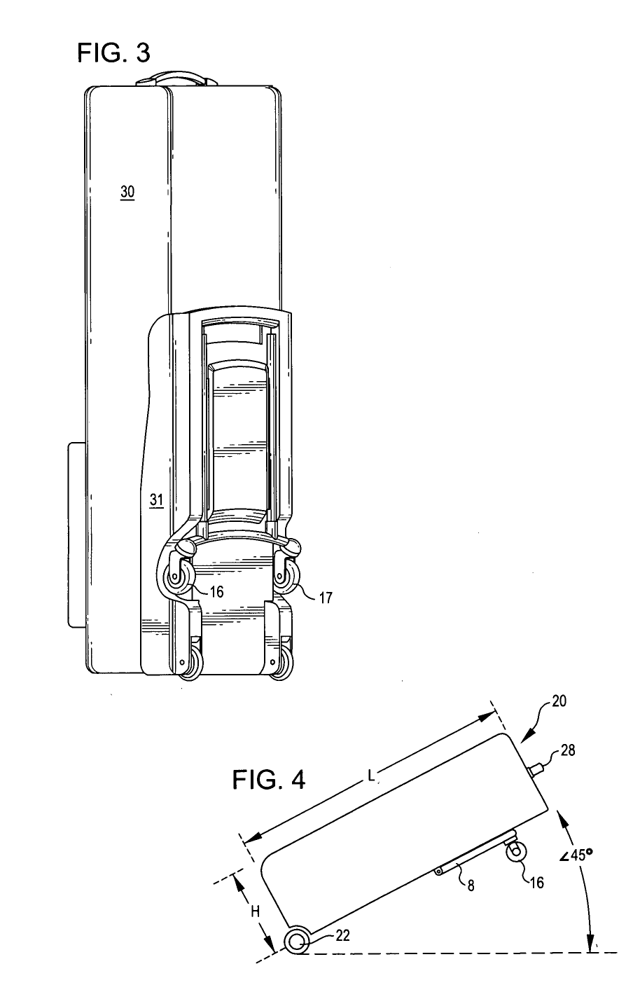

FIG. 3 shows an embodiment where the extendable support 8 is attached to an attachment structure 31, like in FIG. 1, but the attachment structure 31 is designed to fit only one shape and size of case 30. The attachment structure is permanently attached to the case with some combination of rivets, bolts, adhesive, or other fasteners.

FIGS. 2 and 3 show an embodiment wherein the extendable support 8 collapses downward such that the wheels 16, 17 are nearer a wheeled end of the case when the extendable support is collapsed. FIG. 4 shows an embodiment wherein the extendable support 8 collapses upward such that, when the extendable support is collapsed, the wheel 16 is near the handle end of the case.

The length L of the travel case, as shown in FIG. 4, is more than 40 inches and the handle protrudes from the case less than 6 inches. In typical embodiments for golf travel cases, the length ranges from 45 inches to 72 inches and the handle protrudes less than 4 inches.

In one embodiment, the pivotal attachment of the support 8 to the case 20 or the attachment structure 2 is the same as for legs on a folding table. Similarly, the locking mechanism 14 may be the same as the locking mechanism for legs on a folding table. Any other hinged design suitable for folding legs and any other designs for the locking mechanism would be suitable. Preferably, there is a means for holding the leg in place when it is collapsed. In one embodiment, such a means consists of friction points on the locking mechanism 14 that hold the leg in a collapsed position by applying friction. The friction points may be protrusions on one-half of the locking mechanism 14 which engage with recesses on the other half of the locking mechanism 14 when the locking mechanism is bent at a hinge point which allows the two halves of the mechanism to pivot relative to each other until they overlap.

In an alternative embodiment, the extendable support may be designed to collapse with a different motion. For example, the support may comprise two legs, each having a wheel at one end and being attached to a structural pole approximately following each of the long edges of the base of the travel case. Each leg may be formed with two members, forming a triangle with the pole, or it may be formed with a flat panel substantially in the shape of a triangle. The attachment of the leg to the pole may allow the leg to pivot about an axis that is within or parallel to the pole. This allows each leg to pivot independently toward or away from the other leg, allowing them to fold against the base of the case, first one leg, then the other leg on top of the first, or away from each other against the sides of the case. In these embodiments, the locking mechanisms support each leg against sideways movement about its pivot axis, which is within or along side the pole, rather than supporting the leg against movement angular to such a pole.

Although the present invention has been described in considerable detail with reference to certain preferred embodiments, other embodiments are possible. Therefore, the spirit or scope of the appended claims should not be limited to the description of the embodiments contained herein. It is intended that the invention resides in the claims hereinafter appended.

1. An add-on support for wheeled travel cases, comprising:
(a) an attachment structure attachable to a side of a wheeled travel case,
(b) an elongated extendable support having an attachment end and a wheeled end, the attachment end attached to the attachment structure,
(c) a locking mechanism that locks the extendable support in an extended position relative to the attachment structure, and
(d) at least one support wheel mounted on the wheeled end of the extendable support; and
(e) straps attached to the attachment structure in positions suitable for strapping the attachment structure to a wheeled travel case.

2. The add-on support of claim 1 wherein the extendable support has two attached wheels.

3. The add-on support of claim 1 wherein the at least one wheel is a caster wheel with a pivot axis that is substantially vertical when the extendable support is extended and an attached travel case is tilted until the support wheel carries load on a level surface.

4. The add-on support of claim 1 further comprising a hook that restrains upward movement of the attachment structure relative to a case to which it is attached.

5. The add-on support of claim 4 wherein the extendable support is pivotally attached to the attachment structure such that when the extendable support is collapsed, the at least one wheel is near a lower end of the attachment structure.

6. The add-on support of claim 4 wherein the extendable support is pivotally attached to the attachment structure such that when the extendable support is collapsed, the at least one wheel is near an upper end of the attachment structure.

7. A long wheeled travel case with an extendable wheeled support, comprising:
(a) a travel case having a base with two edge wheels mounted on an edge between the base and a side of the case and having a length of the base to one side of the edge greater than 40 inches and a height to the other side of the edge less than half of the length;
(b) a handle at a top of the travel case opposite the edge wheels which handle extends from the case no more than six inches;
(c) an extendable support having a length, an attachment end, and a wheeled end, the attachment end attached to the tilt side of the travel case at a pivot location;
(d) at least one caster wheel mounted on the wheeled end of the support;
(e) a locking mechanism that locks the extendable support in an extended position angle formed between the travel case and the support; wherein
(f) the length of the extendable support combined with the pivot location and the extended position angle cause the travel case to be raised from a horizontal position less than 45 degrees when the at least one caster wheel and edge wheels carry weight on level ground.

8. The case of claim 7 wherein the case is hard.

9 The case of claim 7 wherein the case is soft.

10. The case of claim 7 wherein the extendable support has two attached caster wheels.

11. The case of claim 7 wherein the at least one caster wheel has a pivot axis that is substantially vertical when the extendable support is extended and the travel case is raised such that the at least one caster wheel carries load on a level surface.

12. The case of claim 7 wherein the extendable support is pivotally attached to the travel case such that, when the extendable support is collapsed, the at least one caster wheel is near the wheeled end of the case.

13. The case of claim 7 wherein the extendable support is pivotally attached to the travel case such that, when the extendable support is collapsed, the at least one caster wheel is far from the wheeled end of the case.

14. A long, wheeled travel case with an extendable wheeled support, comprising:
a travel case having a base with two edge wheels mounted on an edge between the base and a side of the case and having a length of the base to one side of the edge greater than 40 inches and a height to the other side of the edge less than half of the length;
a handle at a top of the travel case opposite the edge wheels which handle extends from the case no more than six inches;
an extendable support having a length, an attachment end, and a wheeled end, the attachment end attached to the tilt side of the travel case at a pivot location;
at least one support wheel mounted on the wheeled end of the support;
a locking mechanism that locks the extendable support in an extended position angle formed between the travel case and the support; wherein
the length of the extendable support combined with the pivot location and the extended position angle cause the travel case to be raised from a horizontal position less than 45 degrees when the support wheels and edge wheels carry weight on level ground.

15. A long, wheeled travel case with an extendable wheeled support, comprising:
a travel case having a base with two edge wheels mounted on an edge between the base and a side of the case and having a length of the base to one side of the edge greater than 40 inches and a height to the other side of the edge less than half of the length;
a handle at a top of the travel case opposite the edge wheels which handle extends from the case no more than six inches;
an extendable support having a length, an attachment end, and a wheeled end, the attachment end attached to the tilt side of the travel case at a pivot location;
at least one support wheel mounted on the wheeled end of the support;
a locking mechanism that locks the extendable support in an extended position angle formed between the travel case and the support; wherein
the travel case is substantially stiff along its length, and the length of the extendable support combined with the pivot location and the extended position angle cause the travel case to be raised from a horizontal position less than 45 degrees when the support wheels and edge wheels carry weight on level ground.

16. The case of claim 15 wherein the base is substantially stiff along its length.
